(19) United States
(12) Patent Application Publication
(10) Pub. No.: US 2023/0061484 A1
(43) Pub. Date: Mar. 2, 2023

(54) METHOD OF MAKING LOW-SUGAR CARAMELS

(71) Applicant: THE HERSHEY COMPANY, Hershey, PA (US)

(72) Inventors: Yumin You, Hummelstown, PA (US); Chelsea Denise Hager, Harrisburg, PA (US); Supapong Siris, Hummelstown, PA (US); John Edward Bennett, JR., Mechanicsburg, PA (US); Yvette Thibault Pascua Cubides, Palmyra, PA (US)

(21) Appl. No.: 17/446,389

(22) Filed: Aug. 30, 2021

(51) Int. Cl. A23G 3/44; A23G 3/42; A23G 3/40; A23G 3/32; A23G 3/54; A23J 3/08; A23L 7/126; A23L 33/19

(52) U.S. Cl. CPC A23G 3/44; A23G 3/42; A23G 3/40; A23G 3/32; A23G 3/54; A23J 3/08; A23L 7/126; A23L 33/19; A23V 2002/00

(57) ABSTRACT

A caramel includes water, glycerol, fat, and about 10% by weight or greater of at least one protein source including at least one protein. A method of forming a caramel includes combining water, glycerol, fat, and about 10% by weight or greater of at least one protein source including at least one protein to form a caramel composition. The method also includes hydrating the protein at a hydrating temperature less than a denaturation temperature of the protein to achieve the caramel having a predetermined water activity without denaturing the protein. The caramel includes about 25% by weight or greater of the protein source, and the protein is not in a denatured state in the caramel. A comestible product includes a protein core layer and a layer of a slab-able caramel adhering to the protein core layer.

### FIELD OF THE INVENTION

This application is directed to caramels and methods of making. More particularly, the present application is directed to comestible caramels with reduced simple sugar content and increased protein content and methods of making.

### BACKGROUND OF THE INVENTION

Conventional caramels are a complex blend of fat globules in varying size surrounded by a high-concentration sugar solution in which non-fat milk solids are dispersed or dissolved. It is conventionally manufactured by heating a mixture of glucose syrup, milk, and vegetable fat to a temperature ranging between 118° C. and 130° C.

Caramels generally constitute a wide classification of milk-based confections with varied texture from a creamy smooth fluid caramel to a hard candy-type caramel, depending primarily on water content. The water content of caramel may be as low as 4-5% and as high as about 18%, leading to different textures. Caramels with low water content (4%) have a glass transition temperature above room temperature and behave like hard candy. Caramels with a high water content (18%) may be fluid and runny, suitable for use as a sauce or for depositing into a mold, such as a starch mold, a starchless mold, or a chocolate shell. Many commercial caramels have a water content of about 10%, giving a texture that is firm yet chewy with minimal cold flow.

Caramels are viscous materials. The viscosity is associated with processing capability including pumping, being delivered, and being handled. Depending primarily on the sucrose to glucose syrup ratio, conventional caramels can be either partially grained (5-15% sugar crystals), with a relatively short texture, or ungrained (less than 5% sugar crystals), with a stretchy and chewy texture.

Attempts have been made to prepare caramel with minimal sugar content. Neither sugar sources, including sugars, corn syrups, and glucose syrups, nor sugar alcohols are applied in such formulas. Low sugar versions of caramels can be found, where a sugar alcohol, such as sorbitol, mannitol, maltitol, isomalt, lactitol, or xylitol, replaces the sucrose and some longer-chain polymeric sweetener, such as soluble corn fiber, polydextrose, or hydrogenated starch hydrolysate, replaces the glucose syrup. High-intensity sweeteners may be needed in such low sugar caramels to provide a desirable sweetness. Also, without substantial reducing sugars such as lactose and glucose, browning reactions do not occur and the caramel must have appropriate color and flavor added.

Conventional caramels are produced by heating the sugar syrup to dissolve crystalline sugars, hydrate larger carbohydrates and/or proteins, and reduce moisture content to achieve a target water activity level. However, high temperature (>70° C.) promotes protein denaturation and consequently protein aggregation, resulting in an off-white opaque material.

Attempts have been made to create a slab-able high protein caramel, including employing glycerol to maintain water activity at higher moisture levels, adding hydrocolloids to achieve minimal cold flow and/or applying high processing temperatures to functionalize the proteins into an effective caramel component. When no sugar or low sugar is added, large amounts of a dairy protein or protein blends need a high processing temperature to create the texture desirable for end-use products.

To apply a caramel as a layer in a protein bar or cereal bar or other foodstuffs, the caramel needs to have an increased moisture level to increase its capability of being deformed (such as slab-ability). However, by increasing the moisture level of caramel without the use of syrups, gums, and humectants, the caramel has an increased water activity that may bring with it microbial risk. Also, a caramel with increased moisture can be too sticky on its outer surfaces, causing problems when the bar is processed through the compression rollers, slitter knives, and guillotine blades because the bar dough may ball-up or pick-off onto the equipment. Additionally, high moisture caramel can be too soft to keep it from flowing or to retain its shape in the bar.

A successful caramel maintains a water activity and a moisture content that are compatible with the protein core layer in layer bars so as to maintain their desired texture. To apply the caramel in the layer bars, the caramel also needs to have the ability to be spreadable or slab-able on top of the protein core layer with minimal cold flow.

### BRIEF DESCRIPTION OF THE INVENTION

It would be desirable to provide a comestible caramel with reduced simple sugar content and increased protein content and with a predetermined moisture content and water activity level for caramel layer bars, granola bars, cereal bars, and clusters.

Exemplary embodiments are directed to comestible caramels having a reduced simple sugar content and an increased protein content.

Exemplary embodiments employ methods of producing slab-able caramels having a reduced simple sugar content and an increased protein content, where the slab-able caramel has a predetermined water activity that is achieved without denaturing the protein.

Exemplary embodiments employ methods of producing slab-able caramels having a reduced simple sugar content and an increased protein content, where the slab-able caramel can have a range of water activity that is achieved without denaturing the protein.

In an embodiment, a process of forming a slab-able caramel includes combining water, glycerol, fat, and about 10% by weight or greater of at least one protein source including at least one protein to form a caramel composition. The process also includes hydrating the protein at a hydrating temperature less than a denaturation temperature of the protein to achieve the slab-able caramel having a predetermined water activity without denaturing the protein. The slab-able caramel includes about 25% by weight or greater of the protein source, and the protein is not in a denatured state in the slab-able caramel.

In another embodiment, a slab-able caramel includes water, glycerol, fat, and about 10% by weight or greater of at least one protein source including at least one protein.

In another embodiment, a comestible product includes a protein core layer and a layer of a slab-able caramel adhering to the protein core layer.

In an embodiment, a process of forming a caramel includes adding water in an amount selected to reach a predetermined water activity without heating the caramel so the protein source is in a non-denatured state in the caramel.

In another embodiment, a process of forming a caramel includes adding an excess amount of water to the protein source, fat, and glycerol and then eliminating the excess water to reach the predetermined water activity without denaturing the protein.

In another embodiment, a process forms a slab-able caramel with processing conditions selected to generate the caramel with appropriate appearance, texture, and rheological properties.

In some embodiments, a caramel type flavoring agent and color may be added to the final slab-able caramel, since a low-sugar, high-protein caramel may have minimal flavor and color generated from the Maillard reaction and caramelization that occur during conventional caramel processes.

### BRIEF DESCRIPTION OF THE DRAWINGS

FIG. 1 shows a process to produce a slab-able caramel in an embodiment of the present disclosure.

FIG. 2 shows the water activity and moisture of slab-able caramels formed by processes of the present disclosure.

FIG. 3 shows a representative curve of force change with time for a slab-able caramel formed by a process of the present disclosure for a hardness test measured on a TA-XT Plus texture analyzer (Texture Technologies Corp., Hamilton, Mass.) in compression mode.

FIG. 4 shows the average maximum, positive force peak, indicating the hardness of slab-able caramels formed by a process of the present disclosure.

FIG. 5 shows a curve of force change with time of a slab-able caramel formed by a process of the present disclosure for a stickiness test measured on TA-XT Plus texture analyzer in compression mode.

FIG. 6 shows the maximum negative force peak, indicating the stickiness of slab-able caramels formed by processes of the present disclosure.

FIG. 7 shows the travel distance, indicating the stringiness of slab-able caramels formed by processes of the present disclosure.

FIG. 8 shows representative shear stress-shear rate curves for two slab-able caramels formed by a process of the present disclosure measured with a Brookfield R/S Plus rheometer (Brookfield Engineering Laboratories, Inc. Middleboro, Mass.) at 45° C. immediately after processing.

FIG. 9 shows the viscosity-shear rate curves for the same two slab-able caramels as in FIG. 8 immediately after processing.

FIG. 10 shows the viscosity of slab-able caramels formed by processes of the present disclosure measured with a Brookfield R/S Plus rheometer at 45° C. with a shear rate of 7.2 l/s.

FIG. 11 shows the yield stress of slab-able caramels formed by processes of the present disclosure measured on Brookfield R/S Plus rheometer at 45° C. with a shear rate of 0.05 l/s.

FIG. 12 shows the storage modulus and loss modulus of a representative slab-able caramel formed by processes of the present disclosure measured on an Anton Paar rheometer (Anton Paar GmbH, Graz, Austria).

FIG. 13 shows the storage modulus and loss modulus of another representative slab-able caramel formed by processes of the present disclosure.

FIG. 14 shows the change of storage modulus and loss modulus with storage time for the same slab-able caramel as in FIG. 13 for room temperature storage (22° C.).

FIG. 15 shows the differential scanning calorimetry (DSC) curve of a representative slab-able caramel formed by processes of the present disclosure measured on a DSC 2500 differential scanning calorimeter (TA Instruments, New Castle, Del.).

Wherever possible, the same reference numbers will be used throughout the drawings to represent the same parts.

### DETAILED DESCRIPTION OF EXEMPLARY EMBODIMENTS

Disclosed herein are caramels with increased protein content not in a denatured state and/or reduced simple sugar content and processes of making.

Although described herein primarily as being slab-able, caramels of the present disclosure are not so limited.

As used herein, “slab-able” refers to a mass having rheological properties within a range such that the mass is sufficiently soft to be cut or shaped into a slab but sufficiently firm to maintain its shape rather than flowing.

In some embodiments, use of reduced pressure, high shear mixing, and/or one or more of certain soluble dairy proteins enabled development of higher protein, lower sugar caramels for comestible applications such as caramel layer bars.

During development of a reduced sugar caramel by replacement of simple sugars with proteins, it was found that excessive air remains in mass during ingredient loading and high shear mixing, and air removal poses critical technical challenges. Foams were generated either through the ingredients (low density protein powders) or high shearing and were stabilized by proteins dissolved in the glycerol-water solution. Foams caused motor overload because of their high viscosity. The mass temperature quickly increases because of poor cooling resulting from foam insulation. Also, the cooked foam mass was created by inability to remove the air. When pressure was reduced, a high foam volume limited tank capacity and mixing ability. To reduce the foam-related problems, a process for the production of a higher protein, lower sugar caramel was developed.

In some embodiments, a caramel composition includes water, glycerol, and at least one protein source that includes at least one protein.

Although protein is the most predominant component in the protein source, the protein source may also include fat, minerals, salts, sugars, and/or water, depending on the protein source. In some embodiments, the protein source is a protein concentrate of about 80% or more protein by weight. In some embodiments, the protein source is a protein isolate of about 90% or more protein by weight.

In some embodiments, the protein source is a milk protein source. In some embodiments, the milk protein source is a whey protein source, such as, for example, whey protein concentrate or whey protein isolate.

In some embodiments, the protein source is a soluble plant protein source. In some embodiments, the protein source is a protein source selected from outside the group of common allergenic protein sources.

Other appropriate protein sources may include, but are not limited to, pulse protein, lentil protein, chickpea protein, potato protein, rapeseed protein, sunflower protein, algae protein, other milk proteins, or combinations thereof. The protein preferably has an average molecular weight that enables the caramel composition to form a non-opaque slab-able caramel. In some embodiments, the protein has an average molecular weight of about 35 kDa or less. In some embodiments, the average molecular weight of the protein is in the range of about 3 kDa to about 35 kDa, alternatively in the range of about 3 kDa to about 10 kDa, alternatively in the range of about 25 kDa to about 35 kDa, alternatively in the range of about 10 kDa to about 25 kDa, or any value, range, or sub-range therebetween.

In some embodiments, the amount of protein source, by weight, in the caramel composition is in the range of about 15% to about 35%, alternatively about 20% to about 33%, alternatively about 31% to about 33%, alternatively about 31% to about 33%, or any value, range, or sub-range therebetween.

In some embodiments, the amount of protein, by weight, in the caramel composition is in the range of about 10% to about 35%, alternatively about 10% to about 15%, alternatively about 15% to about 20%, alternatively about 20% to about 25%, alternatively about 25% to about 30%, alternatively about 25% to about 33%, alternatively about 31% to about 33%, or any value, range, or sub-range therebetween.

In some embodiments, the amount of glycerol, by weight, in the caramel composition is in the range of about 20% to about 45%, alternatively about 25% to about 42%, alternatively about 30% to about 42%, alternatively about 35% to about 42%, alternatively about 39% to about 42%, or any value, range, or sub-range therebetween.

An appropriate amount of water, by weight, in the caramel composition may be in the range of about 10% to about 30%, alternatively about 11% to about 15%, alternatively about 15% to about 20%, alternatively about 20% to about 25%, alternatively about 25% to about 30%, alternatively about 20% to about 30%, or any value, range, or sub-range therebetween.

In some embodiments, the caramel composition further includes at least one fat. The inclusion of a fat permits a reduction in the amount of glycerol in the slab-able caramel as well as adjusting the texture of slab-able caramel. The fat can be a liquid or a solid at room temperature. The fat may include, but is not limited to, a milk fat, a vegetable oil, sunflower oil, coconut oil, shea oil, palm oil, palm kernel oil, olive oil, canola oil, cocoa butter, cocoa butter substitute, fractionated soy oil, fractionated cottonseed oil, or combinations thereof. In some embodiments, the amount of fat, by weight, in the caramel composition is in the range of about 11% to about 15%.

The caramel composition may optionally include one or more additives. Additives may include, but are not limited to, color, flavoring, salt, soluble fiber, oligosaccharides, hydrolyzed protein, sweetener, sugar alcohol, soluble starch, antifoaming agents, one or more hydrocolloids, which may include, but are not limited to, xanthan gum, guar gum, locust bean gum, gum acacia, or carrageenan, or combinations thereof.

In some embodiments, the caramel composition includes an amount of simple sugars well below that found in conventional caramels. In some embodiments, a small amount of simple sugars and/or sugar syrups is included in the caramel composition, which may permit usage of less glycerol than would otherwise be included in the caramel composition to achieve a given target water activity. In some embodiments, the caramel composition and the resulting slab-able caramel are free or substantially free of simple sugars. As used herein, “substantially free of simple sugars” refers to the slab-able caramel, after removal of water from the caramel composition, including no more than about 1% simple sugars, by weight, not including any simple sugars from the protein source, and no more than about 2% simple sugars, by weight, including any simple sugars from the protein source. It will be appreciated, however, that exemplary embodiments may also include higher amounts of sugars and other carbohydrates.

In some embodiments, the caramel composition and the resulting slab-able caramel are free or substantially free of hydrocolloids.

In some embodiments, the caramel composition and the resulting slab-able caramel are free or substantially free of antifoaming agents.

In some embodiments, the caramel composition is an emulsion. In some embodiments, at least a portion of the water is removed from the caramel composition to achieve a slab-able caramel having a predetermined water activity without heating the composition, and hence the protein source, above the protein source's denaturation temperature. In some embodiments, the water is removed under a reduced pressure or vacuum.

In some embodiments, the slab-able caramel has a similar amount of water as the caramel composition such that the relative amounts of components in the caramel composition and its resulting slab-able caramel are similar.

In some embodiments, the slab-able caramel, after removal of water from the caramel composition, includes, by weight, of the protein source of about 25% or greater, about 25% to about 33%, about 27% to about 33%, about 30% to about 33%, about 32% to about 33%, about 30% or greater, about 25% to about 30%, or any value, range, or sub-range therebetween; by weight, of glycerol of about 50% or less, about 30% to about 50%, about 35% to about 45%, about 45% or less, about 42% or less, about 39% to about 42%, or any value, range, or sub-range therebetween; and by weight, of added fat of about 20% or less, about 5% to about 20%, about 15% or less, about 10% to about 15%, about 13% to about 14%, or any value, range, or sub-range therebetween.

In some embodiments, the denaturation temperature for the protein is about 147° F. (about 64° C.). The denaturation temperature for some fractions of whey protein is in the range of about 147° F. (about 64° C.) to about 169° F. (about 76° C.). When whey protein is the protein source, the vacuum mixing temperature is preferably below 147° F. (64° C.).

In some embodiments, the denaturation temperature for the protein is about 140° F. (about 60° C.). The denaturation temperature for some fractions of potato protein is about 140° F. (about 60° C.). When potato protein is the protein source, the vacuum mixing temperature is preferably below 140° F. (60° C.).

In some embodiments, the denaturation temperature for the protein is in the range of about 185° F. (about 85° C.) to about 224° F. (about 107° C.). The denaturation temperature for some fractions of rapeseed protein is in the range of about 185° F. (about 85° C.) to about 224° F. (about 107° C.). When rapeseed protein is the protein source, the vacuum mixing temperature is preferably below about 185° F. (about 85° C.) to about 224° F. (about 107° C.).

In other embodiments, the denaturation temperature for the protein is in the range of about 149° F. (about 68° C.) to about 158° F. (about 70° C.). The denaturation temperature for some fractions of whey protein is in the range of about 149° F. (about 68° C.) to about 158° F. (about 70° C.). When whey protein is the protein source, the vacuum mixing temperature is preferably below about 149° F. (about 68° C.) to about 158° F. (about 70° C.).

In some embodiments, the slab-able caramel has a water activity of less than about 0.60 and a water content of about 20% or less, by weight. In some embodiments, the water content, by weight, in the slab-able caramel is in the range of about 10% to about 20%, alternatively about 10% to about 18% alternatively about 12% to about 20%, alternatively about 10%, alternatively about 11%, alternatively about 12%, alternatively about 13%, alternatively about 14%, alternatively about 15%, or any value, range, or sub-range therebetween. In some embodiments, the water activity is in the range of about 0.49 to about 0.60, alternatively in the range of about 0.49 to about 0.56, alternatively in the range of about 0.49 to about 0.53, or any value, range, or sub-range therebetween, at a temperature of about 22° C. (70° F.). In other embodiments, the caramel has a water activity of less than 0.49 and may not be slab-able but may be useful as a caramel chew or other more viscous composition. In other embodiments, the caramel has a water activity of greater than 0.60 and may not be slab-able but may be useful as a caramel sauce or other less viscous composition.

In some embodiments, the slab-able caramel has a zero shear viscosity in the range of about 50 to about 450 Pa at 45° C.

In some embodiments, the slab-able caramel has a hardness between 20 g and 400 g, such as, for example, between 30 and 100 g or between 40 and 80 g, at 22° C. measured 24 hours after manufacture.

In some embodiments, the slab-able caramel has a stickiness between 5 g and 80 g, such as, for example, between 7 g and 40 g or between 7 g and 30 g, at 22° C. measured 24 hours after manufacture.

In some embodiments, the slab-able caramel has a stringiness between 3 mm and 12 mm, such as, for example, between 4 mm and 10 mm, at 22° C. measured 24 hours after manufacture.

In some embodiments, the slab-able caramel has a viscosity between 30 Pa·s and 100 Pa·s, such as, for example, between 30 Pa·s and 70 Pa·s or between 30 Pa·s and 60 Pa·s, at 45° C.

In some embodiments, the slab-able caramel has a yield stress between 10 Pa and 250 Pa at 45° C.

In some embodiments, the slab-able caramel includes less than 1% by volume of void space generated during processing by boiling or foaming. In some embodiments, no bubbles or voids are visually observable in the slab-able caramel.

The slab-able caramel may be combined with an inclusion composition to form a comestible product, where the slab-able caramel binds the solid pieces of the inclusion composition to each other. Inclusion ingredients may include, but are not limited to, cereal, seeds, nuts, grains, legumes, dehydrated fruits, dehydrated vegetables, jerky, extruded cereal products, extruded protein products, or combinations thereof.

The slab-able caramel may be combined with an inclusion composition to form a layered comestible product, where the slab-able caramel is slabbed into a layer and placed on top of a protein core layer to form a layer bar. The components of a protein core layer may include, but are not limited to, polysaccharide syrups, soluble fibers, nut butters, nuts, glycerol, flavoring agents, protein powders, or combinations thereof.

Processes disclosed herein created caramel products with a broad range of physical, textural, and rheological attributes, as a consequence for broad applications. In some embodiments, a process of making a slab-able caramel includes combining water, glycerol, optionally fat, and at least one protein source comprising at least one protein to form a caramel composition. The process also includes hydrating the protein at a hydrating temperature less than a denaturation temperature of the at least one protein to achieve the slab-able caramel having a predetermined moisture level or water activity without denaturing the at least one protein. In some embodiments, the process also includes removing water at a dehydrating temperature less than the denaturation temperature of the at least one protein to achieve the slab-able caramel having the predetermined moisture level or water activity without denaturing the at least one protein. The protein is not in a denatured state in the slab-able caramel. In some embodiments, the caramel composition includes at least 10% by weight of the protein source, and the slab-able caramel includes about 25% by weight or greater of the protein source.

Although any method of mixing may be employed in combining the ingredients to form the caramel composition, which may occur at an ambient atmospheric pressure or a reduced pressure, high shear mixing under vacuum is used to combine the ingredients in some embodiments. In some embodiments, the combining occurs in a vacuum high-shear mixer, such as, for example, a Tetra Pak® High Shear Mixer (Tetra Pak, Pully, Switzerland), designed for mixing material under controlled reduced pressure to de-aerate the mass and make it smooth without trapped air bubbles. This vacuum high shear mixer may be designed to generate a homogeneous and lump-free product through an efficient and reliable mixing process. This vacuum high-shear mixer may include a vacuum mixing tank with a mixing unit. The mixing unit may have a rotor and perforated stator to ensure optimal wetting and processing. Mixing under vacuum helps reduce the foam created in beverage and low-viscosity food materials (viscosity≤300 cP). When the material is viscous, however, the process needs modification to improve the product processibility and the quality.

For a highly viscous material, such as certain caramel compositions, it is easy to generate foams during mixing, and it is difficult to remove the massive air bubbles in the mass under reduced pressure. Common antifoaming agents, such as, for example, cetostearyl alcohol, stearates, polydimethylsiloxanes and other silicones derivatives, ether, and glycols, are conventionally used to control the foaming behaviors by altering surface tension characteristics. For a number of reasons, however, it is generally desirable to keep the addition of antifoaming agents to a minimum or eliminate the use of the antifoaming agents by mechanical defoaming devices. To make a low-sugar, high-protein caramel product, mechanical devices bring more risks to introduce the air. In some embodiments, the processes described herein modified and extended the application of a vacuum high-shear mixer, efficiently removed bubbles by generating a boiling phase transition under vacuum to avoid protein denaturation.

In some embodiments, all ingredients are precisely measured and introduced into the system under a reduced pressure, such as, for example, about 500 mbar or less. Protein powders are incorporated into the mixer and are dispersed under high shear. High shear time and speed are adjusted to adequately disperse powders into liquid phase, which is greatly influenced by batch size and initial water content. Powder and liquid ingredients are added into the mixer during circulation. The process continues until all ingredients have been added.

In exemplary embodiments, the combining includes combining water, glycerol, fat, salt, and about 1% by weight or greater, such as about 5% by weight or greater, such as about 10% by weight or greater, of at least one protein to form and maintain a caramel composition as an emulsion during processing. In exemplary embodiments, the vacuum pressure of a vacuum high-shear mixer is set to 500 mbar, and the weighed liquid ingredients are added into a first hopper of the vacuum high-shear mixer. The liquids are introduced into the mixer by opening the inlet valve, and the valve is closed once all liquids have exited the first hopper. Homogenization of the liquid in the mixer is begun under a no-shear mixing mode of the impeller motor, a motor speed in the range of 25-70%, and an agitator speed of 20-25%. The weighed solid ingredients are added to a second hopper. The solids are introduced into the mixer by opening the inlet valve, and the valve is closed once all solids have exited the second hopper. The impeller motor is then adjusted to a high-shear mode, and the mass is mixed in the high-shear mode for 2-10 minutes. If the mass temperature exceeds 45° C. during high-shear mixing, cooling is applied by a cooling jacket with the setting temperature to 2° C.

In some embodiments, continuous mixing at 40-60° C. facilitates protein powders to achieve the full hydration and consequently generates the homogeneous mass. Shear speed and agitator speed are selected to produce a uniform mass without denaturing the protein.

In some embodiments, the amount of water in the caramel composition is at or near the water content of the finished caramel composition, with the protein becoming sufficiently hydrated during the mixing step, such as, for example, high shear mixing and which may be under a reduced pressure. In such cases, a subsequent water removal step may be omitted or the length of the subsequent water removal step may be shortened if lesser amounts of water need to be removed.

In other embodiments, the amount of added water is in excess of the total amount of water content in the finished slab-able caramel and a predetermined amount of the water is removed as described herein.

In some embodiments, the process includes heating the caramel composition to a temperature that is above ambient or room temperature but below the denaturation temperature of the protein in the caramel composition to remove water from the caramel composition until a slab-able caramel with a predetermined water activity is achieved. In some embodiments, the process is a batch process. In other embodiments, the process is a continuous process.

To achieve a targeted water activity level, a vacuum or reduced pressure, which operates at a vacuum temperature below the protein denaturation temperature, may be employed to reduce moisture content.

In some embodiments, the heating of the caramel composition to remove water is performed while applying a reduced pressure to the caramel composition. In some embodiments, the process further includes stirring the caramel composition while heating and applying a reduced pressure. In some embodiments, the stirring is a low-shear or no-shear stirring.

In some embodiments, the heating of the caramel composition to remove water is performed by a vacuum high-shear mixer, such as, for example, a Tetra Pak® High Shear Mixer, which may also provide a reduced pressure and/or a low-shear or high-shear mixing during the water removal.

In some embodiments, after high-shear mixing, the impeller motor is returned to no-shear mode. The pressure is then gradually and steadily lowered from 500 mbar until reaching a corresponding pressure setpoint to induce boiling. Once the mass is boiling, mass turnover is sufficient enough to enable air bubble exposure to the low atmosphere, causing the air bubble to burst and release.

In some embodiments, the pressure is reduced gradually, such as, for example, from 500 mbar to 90 mbar, to create boiling conditions. The mass volume may increase with decreasing air pressure, which is also influenced by batch size and initial water content. Shear speed may be adjusted to lower mass height and at the same time maintain the mass temperature near the boiling point.

When the mass temperature reaches the boiling point at a certain reduced pressure, the mass starts to boil at a temperature lower than the denaturation temperature of the protein source. The vacuum, the shear speed, and temperature may be modified to create a heavy boiling, which includes cycles of violent turnover and calming. This is the main stage to remove the moisture and achieve the predetermined water activity.

Heavy vacuum boiling is also an efficient way to remove any excessive foam to obtain a product with a smooth surface. When incorporating ingredients and mixing the mass under warm temperature and high shear, a lot of foam may be generated, which may cause motor overload, generate excessive heat by increasing mass viscosity, and make it difficult to control mass temperature below protein denaturation temperature. Antifoaming agents have been tried to eliminate the foam, but the usage level needs to be high to achieve a satisfactory result, and antifoaming agents are generally not desired in foods for a number of reasons. In exemplary embodiments, the process provides an efficient method to burst and release most of the air bubbles in the final product without the use of an antifoaming agent.

Once a predetermined boiling time is achieved, all mixing is stopped by setting the motor speeds of the mixer and the agitator to 0%. The vacuum pressure is gradually released to atmospheric pressure, approximately 1000 mbar. The outlet pump is then connected to the discharge valve. To assist pumping, the agitator speed is set to 20%. Once the slab-able caramel mass is completely discharged, the agitator speed is set to 0%.

In some embodiments, the caramel functions as a binder, and the process further includes mixing the caramel with a plurality of inclusions and baking the mixture to form a comestible product.

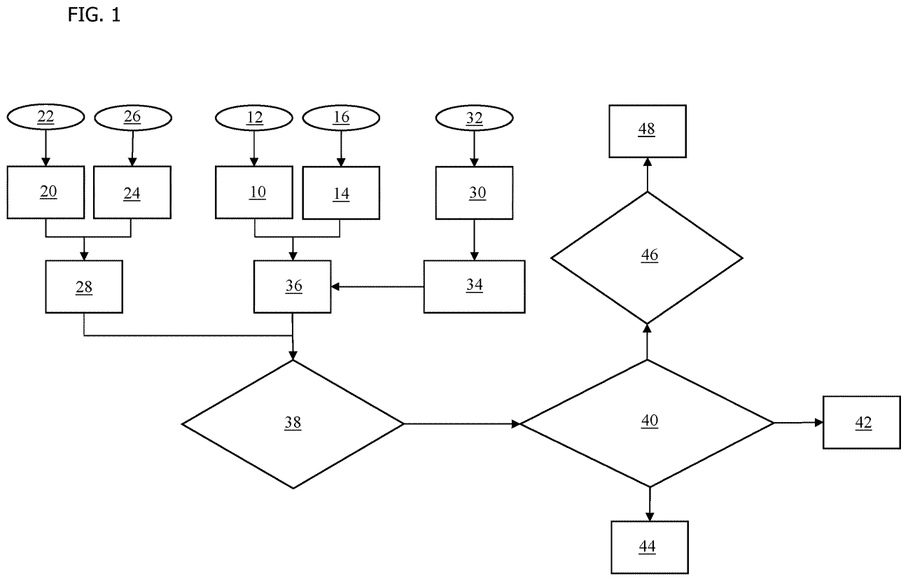

Referring to FIG. 1, a process includes weighing 10 water 12 and weighing 14 glycerol 16. The process also includes weighing 20 a protein source 22 and weighing 24 salt 26 and dry blending 28 the protein source 22 and the salt 26 together. The process further includes metering 30 a fat 32 and applying heat 34 to increase the fat 32 to a predetermined temperature to melt fat crystals and reduce the viscosity of the fat 32. The process then includes blending 36 the water 12, glycerol 16, and fat 32 together to form an oil-in-water emulsion. The process also includes mixing 38 the dry blend and the emulsion together in a mixing tank to dispense the dry blend in the emulsion, hydrate the protein source 22, shear the mixture, create a stabilized emulsion, and control the temperature. The process further includes vacuum boiling 40 the mixed composition to develop certain color, to increase the viscosity, and to achieve a predetermined water content or water activity, which may include moisture removal, with temperature maintenance and with deaeration and agitation to reduce foaming. Air 42 and condensate 44 are removed during the vacuum boiling 40. Upon completion of vacuum boiling 40, the process includes releasing the vacuum and cooling 46. The process then includes pumping 48 the produced mass from the mixing tank.

### EXAMPLES

The invention is further described in the context of the following examples which are presented by way of illustration, not of limitation. The amount of water listed in the below ingredient tables does not include water or moisture that was provided by the other ingredients listed in the tables. The first inventive example was prepared by a batch process in a Stephan Mixer (A. Stephan & Sohne GmbH, Hamelin, Germany) starting from a caramel composition containing excessive water. The rest of the examples were prepared by batch processes in a Tetra Pak® High Shear Mixer starting from a caramel composition containing only sufficient water to fully hydrate the protein powder and generate the homogeneous mass with the target water activity without excessive additional processes. Including the few examples were selected to describe the invention, a total of 16 runs of the inventive process on a Tetra^{Pak}® High Shear Mixer were performed. The principles described herein may be applied to batch or continuous processes on a benchtop scale or a large production scale.

### Inventive Example 1

The whey protein isolate, which was the protein source, and salt were combined in the amounts listed in Table 1 in one container. The water, glycerol, and coconut oil, which was the fat source, in the amounts listed in Table 1 were combined in a separate container. The Stephan Mixer was connected with a FreezeMobile 25EL Freeze Dryer (SP Vir Tis, SP Scientific, Stone Ridge, N.Y.). A water bath at 50° C. was prepared to warm up the bowl before loading material. The liquid ingredients were loaded into the bowl first. The vacuum valve was opened until the gauge on the instrument reached a pressure of about −0.85 to −0.95 Bar and was then closed. This maintained a vacuum within the bowl. The liquids were mixed at a shear speed of 1 until all liquids were homogeneously dispersed and the solid fats were melted. The vacuum in the bowl was then released. The bowl was then opened and the powder ingredients were added. The vacuum valve was opened again until a pressure of −0.85 to −0.95 Bar was reached, and the valve was then closed to maintain vacuum in the bowl. The material was pulsed at a speed of 1 a few times to wet the powder. The material rose to the top of the lid as the vacuum valve was opened and shear was used to bring material back down.

TABLE 1
Inventive Example 1 Ingredients

| Ingredient | Wt. % | Batch (g) |
|---|---|---|
| Water | 25.348 | 380.22 |
| Glycerol | 34.519 | 519.27 |
| Whey Protein Isolate 90% | 27.260 | 408.90 |
| Salt | 0.700 | 10.51 |
| Coconut oil | 11.453 | 171.79 |
| Flavoring | 0.600 | 7.51 |
| Color | 0.120 | 1.8 |

The shear speed was increased to 2 and then 3. Once a good equilibrium was reached, the vacuum valve was fully opened and left open. This enabled the removal of moisture vapors. The material remained on the lower part of the bowl, boiling and shearing. Shearing and moisture removal continued until a target water activity level was reached. At this stage, some material had built up on the side of the bowl. This material was scraped off and mixed into the mass before sampling. The slab-able caramel mass was collected for measurement of its water activity and moisture.

The slab-able caramel mass had a water activity of 0.59 at 25° C. and moisture content of 18.7%. The caramel had a translucent appearance without visible air bubbles trapped inside.

The flavoring and color were blended into the mass to form a slab-able caramel mass as a first inventive example (IE1).

### Inventive Example 2

Cocoa butter substitute, which was the fat source, water, and glycerol were weighed in the amounts shown in Table 2 and then combined in the tank of a Tetra Pak® High Shear Mixer by blending for 10-15 minutes at a motor speed of 24% and a reduced pressure of 500 mbar. The whey protein concentrate, which was the protein source, and salt were then added and blended into the mixture at a motor speed of 36-60%. The motor speed was adjusted when more protein powder was incorporated into the mixture. After all powders were added, the station position was changed to the “High Shear” setting for five minutes and then switched to “No Shear” for two minutes. Mixing continued while the pressure was further reduced from 500 mbar to 150 mbar to achieve a homogeneous mixture.

TABLE 2
Inventive Examples 2 and 3 Ingredients

| Ingredient | Wt. % | Batch (lbs) |
|---|---|---|
| Water | 14.99 | 62.07 |
| Glycerol | 39.76 | 164.61 |
| Cocoa butter substitute | 13.15 | 54.42 |
| Whey Protein Concentrate 80% | 31.31 | 129.61 |
| Salt | 0.79 | 3.29 |
| Flavoring | | 2.40 |
| Color | | 0.76 |
| Sweetener | | 0.04 |

The pressure was further reduced below 150 mbar, which significantly increased the mixture's volume. A further increase in the motor speed maintained the process capability under vacuum. The total mixing time was 30 min. The mixture started to boil at a pressure below 90 mbar with the motor speed at 88%. After 6 min, the boiling stopped and all mixing was stopped by setting the motor speeds of the mixer and agitator to 0%. The reduced pressure was gradually released to return to atmospheric pressure, approximately 1000 mbar. The agitator speed was set to 20% to assist pumping the mass out of the tank of the Tetra Pak® High Shear Mixer. Once the product was completely discharged, the agitator speed was set to 0%. The mass was collected for measurement of its water activity, moisture, texture, and rheology.

The slab-able caramel mass had a water activity of 0.58 at 25° C. and moisture content of 16.4%. The initial water content was 16.57% including the added water and the moisture from other ingredients, such as the whey protein concentrate.

The flavoring, color, and sweetener were added toward the end of the process to minimize flavor loss and blended into the mass to form a slab-able caramel mass as a second inventive example (IE2). The flavoring, color, and sweetener may be added prior to discharge from the high shear mixer or after discharge. Addition of the flavoring, color, and sweetener did not measurably change the water activity or other properties of the mass.

### Inventive Example 3

Cocoa butter substitute, which was the fat source, water, and glycerol were weighed in the amounts shown in Table 2 and then combined in the tank of a Tetra Pak® High Shear Mixer by blending for 10-15 minutes at a motor speed of 24% and a reduced pressure of 500 mbar. The whey protein concentrate, which was the protein source, and salt were then added and blended into the mixture at a motor speed of 36%. The motor speed was adjusted when more protein powder was incorporated into the mixture. After all powders were added, the station position was changed to the “High Shear” setting for 5 minutes and then switched to “No Shear” for 2 minutes. Mixing continued while the pressure was further reduced from 500 mbar to 150 mbar to achieve a homogeneous mixture.

The pressure was further reduced below 150 mbar, which significantly increased the mixture's volume. A further increase in the motor speed to 88% maintained the process capability under vacuum. The total mixing time was 80 min. All mixing was stopped by setting the motor speeds of the mixer and agitator to 0%. The reduced pressure was gradually released to return to atmospheric pressure, approximately 1000 mbar. The agitator speed was set to 20% to assist pumping the mass out of the tank of the Tetra Pako High Shear Mixer. Once the product was completely discharged, the agitator speed was set to 0%. The mass was collected for measurement of its water activity, moisture, texture, and rheology.

The slab-able caramel mass had a water activity of 0.58 at 25° C. and moisture content of 18.1%. The flavoring, color, and sweetener were added and blended into the mass to form a slab-able caramel mass as a third inventive example (IE3). The same starting formula generated caramels (IE2 and IE3) with similar water activity but different moisture under different processing conditions and different textural and rheological properties, as discussed in detail below.

### Inventive Example 4

Cocoa butter substitute, which was the fat source, water, and glycerol were weighed in the amounts shown in Table 3 and then combined in the tank of a Tetra Pak® High Shear Mixer by blending for 10-15 minutes at a motor speed of 24% and a reduced pressure of 500 mbar. The whey protein concentrate, which was the protein source, and salt were then added and blended into the mixture at a motor speed of 36%. The motor speed was adjusted when more protein powder was incorporated into the mixture. After all powders were added, the station position was changed to the “High Shear” setting for 5 minutes and then switched to “No Shear” for 2 minutes. Mixing continued while the pressure was further reduced from 500 mbar to 150 mbar to achieve a homogeneous mixture.

TABLE 3
Inventive Example 4 Ingredients

| Ingredient | Wt. % | Batch |
|---|---|---|
| Water | 10.93 | 45.24 |
| Glycerol | 41.33 | 171.11 |
| Cocoa butter substitute | 13.66 | 56.57 |
| Whey Protein Concentrate 80% | 32.54 | 134.73 |
| Salt | 0.83 | 3.42 |
| Flavoring | | 2.40 |
| Color | | 0.76 |
| Sweetener | | 0.04 |

The pressure was further reduced below 150 mbar, which significantly increased the mixture's volume. A further increase in the motor speed maintained the process capability under vacuum. The total mixing time was 30 min. The mixture started to boil at a pressure below 90 mbar with the motor speed at 88%. The pressure was further reduced to 85 mbar and the motor speed was increased to 98%. The mass boiled for 12 min. All mixing was then stopped by setting the motor speeds of the mixer and agitator to 0%. The reduced pressure was gradually released to return to atmospheric pressure, approximately 1000 mbar. The agitator speed was set to 20% to assist pumping the mass out of the tank of the Tetra Pak® High Shear Mixer. Once the product was completely discharged, the agitator speed was set to 0%. The mass was collected for measurement of its water activity, moisture, texture, and rheology.

The caramel mass had a water activity of 0.47 at 25° C. and moisture content of 10.17%. The initial water content in the caramel composition was 12.58%. The flavoring, color, and sweetener were added and blended into the mass to form a slab-able caramel mass as a fourth inventive example (IE4). IE4 had the highest hardness and stickiness, making it difficult to be slabbed but still useful in certain products, for example, caramel chews. In exemplary embodiments, a slab-able caramel has a water activity of 0.49 or greater.

### Inventive Example 5

Cocoa butter substitute, which was the fat source, water, and glycerol were weighed in the amounts shown in Table 4 and then combined in the tank of a Tetra Pak® High Shear Mixer by blending for 10-15 minutes at a motor speed of 24% and a reduced pressure of 500 mbar. The whey protein concentrate, which was the protein source, and salt were then added and blended into the mixture at a motor speed of 36%. The motor speed was adjusted when more protein powder was incorporated into the mixture. After all powders were added, the station position was changed to the “High Shear” setting for 5 minutes and then switched to “No Shear” for 2 minutes. Mixing continued while the pressure was further reduced from 500 mbar to 150 mbar to achieve a homogeneous mixture.

TABLE 4
Inventive Example 5 Ingredients

| Ingredient | Wt. % | Batch |
|---|---|---|
| Water | 11.91 | 42.50 |
| Glycerol | 41.20 | 147.10 |
| Cocoa butter substitute | 13.62 | 48.63 |
| Whey Protein Concentrate 80% | 32.44 | 115.82 |
| Salt | 0.82 | 2.94 |
| Flavoring | | 2.08 |
| Color | | 0.66 |
| Sweetener | | 0.03 |

The pressure was further reduced below 150 mbar, which significantly increased the mixture's volume. A further increase in the motor speed maintained the process capability under vacuum. The total mixing time was 37 min. The mixture started to boil at a pressure below 90 mbar with the motor speed at 88%. The pressure was further reduced to 85 mbar and the motor speed was decreased to 80%. After 9 min, the boiling stopped and all mixing was stopped by setting the motor speeds of the mixer and agitator to 0%. The reduced pressure was gradually released to return to atmospheric pressure, approximately 1000 mbar. The agitator speed was set to 20% to assist pumping the mass out of the tank of the Tetra Pak® High Shear Mixer. Once the product was completely discharged, the agitator speed was set to 0%. The mass was collected for measurement of its water activity, moisture, texture, and rheology.

The slab-able caramel mass had a water activity of 0.51 at 25° C. and moisture content of 14.36%. The initial water content in the caramel composition was 13.65%. The flavoring, color, and sweetener were added and blended into the mass to form a slab-able caramel mass as a fifth inventive example (IE5).

### Inventive Examples 6-14

Additional inventive examples were formed from a similar caramel composition and by a similar process to that of IE2, IE3, and IE5. A sixth inventive example (IE6), a seventh inventive example (IE7), an eighth inventive example (IE8), a nineth inventive example (IE9), a tenth inventive example (IE10), an eleventh inventive example (IE11), a twelfth inventive example (IE12), a thirteenth inventive example (IE13), and a fourteenth inventive example (IE14) differed slightly from each other and from IE2, IE3, and IE5 in their starting water content, their processing times, pressures, and/or temperatures, and/or their target water activities, with all resulting in a slab-able caramel mass that was further tested for comparison to the other inventive examples.

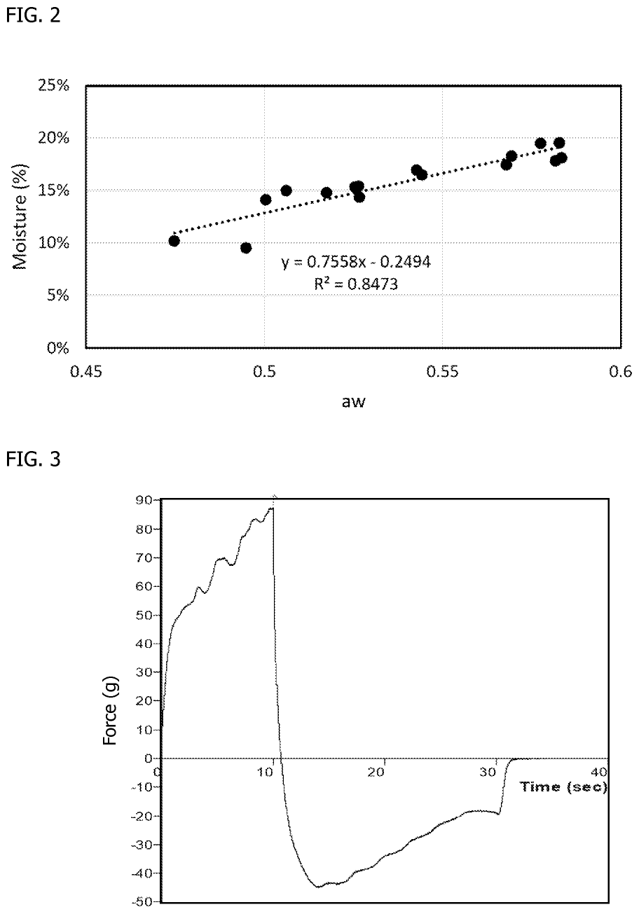

FIG. 2 shows that the relationship between moisture content and water activity was approximately linear for slab-able caramels formed by the processes described herein. Including the inventive examples described above, a total of 16 runs were completed to form slab-able caramel, with representative data from those additional runs also being shown in FIG. 2. FIG. 2 shows that slab-able caramels with a water activity ranging from 0.49 to 0.60 can be produced by providing certain starting amounts of water (10-16%) sufficient to hydrate the protein powder and achieve the target water activity using the controlled vacuum boiling process described herein.

### Experimental Testing.

The inventive examples were further tested for textural and rheological properties. IE1, IE2, and IE3 all started with the same relative amounts of glycerol, protein, fat, and salt but differed in the relative amount of starting water. Starting from different amount of water prior to processing and adjusting processing conditions, such as, for example, air pressure, motor speed, processing time, or combinations thereof, produced slab-able caramel products of varied texture, such as, for example, hardness, stickiness, or combinations thereof, which can be used in different applications.

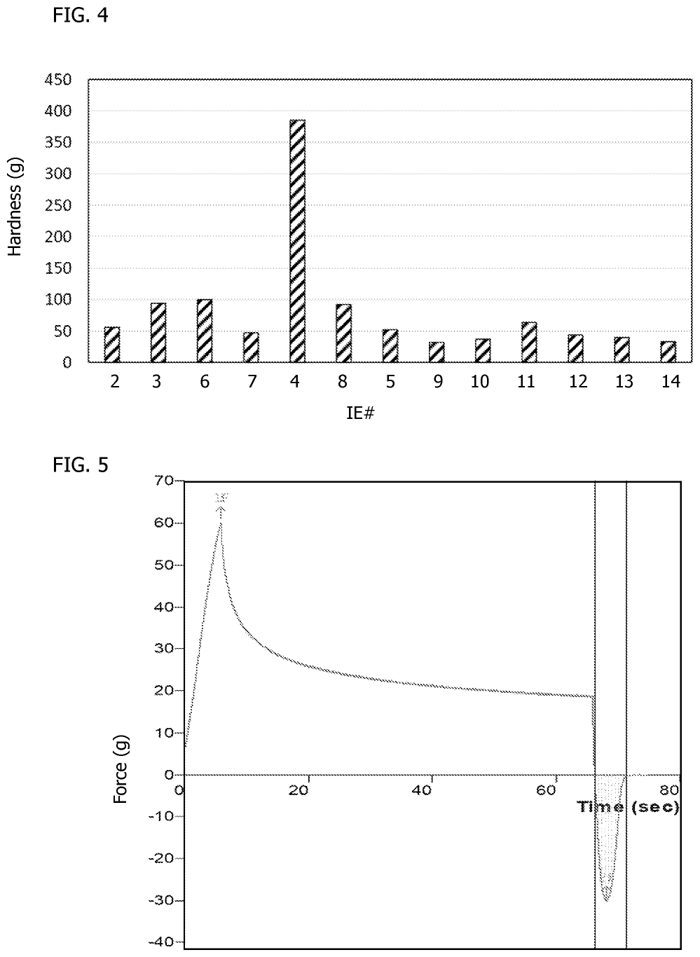

IE2-IE14 were tested for hardness with a TA-XT Plus texture analyzer in compression mode. The hardness measurement was performed at 22° C. with a 5-kg load cell and a 4-mm probe. FIG. 3 shows a representative time-force curve from a hardness test performed on IE6 24 hours after manufacture. The largest recorded positive force represents the hardness of the sample. FIG. 4 shows the hardness for IE2-IE14. Each graphed value is the average of three measurements. As shown in FIG. 4, IE2, IE3, IE4, and IE5 had an average hardness of 94.2 g, 56.0 g, 385 g, and 51.7 g, respectively.

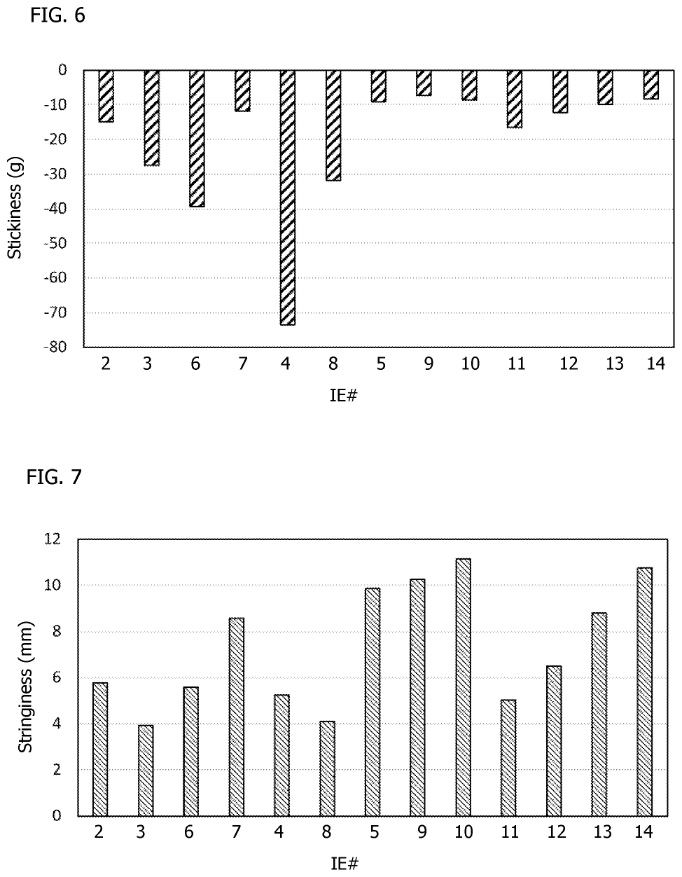

IE2-IE14 were also tested for stickiness and stringiness with a TA-XT Plus texture analyzer in compression mode. The stickiness and stringiness measurement was performed at 22° C. with a 5-kg load cell and a 6-mm ball probe. FIG. 5 shows a representative time-force curve from a stickiness/stringiness test performed on one of the inventive examples 24 hours after manufacture. The largest recorded negative force represents the stickiness of the sample. The distance over which a negative force is recorded is the stringiness of the sample. As shown in FIG. 6, IE2, IE3, IE4, and IE5 had an average stickiness of 27.4 g, 15.0 g, 73.5 g, and 9.2 g, respectively. Each graphed value is the average of three measurements. As shown in FIG. 7, IE2, IE3, IE4, and IE5 had an average stringiness value of 3.9 mm, 5.8 mm, 5.2 mm, and 9.9 mm, respectively. Each graphed value is the average of three measurements.

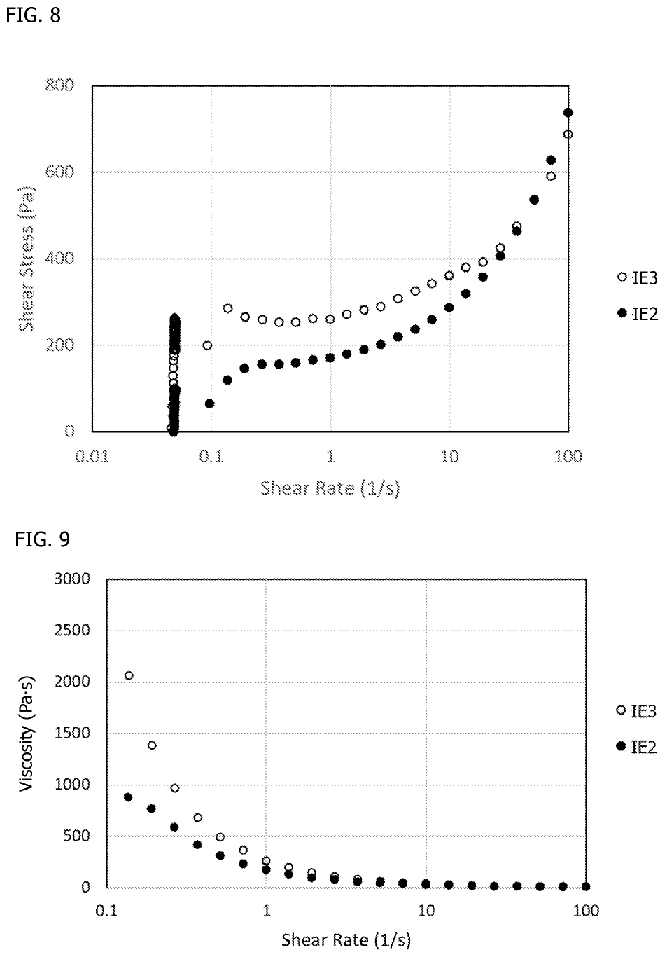

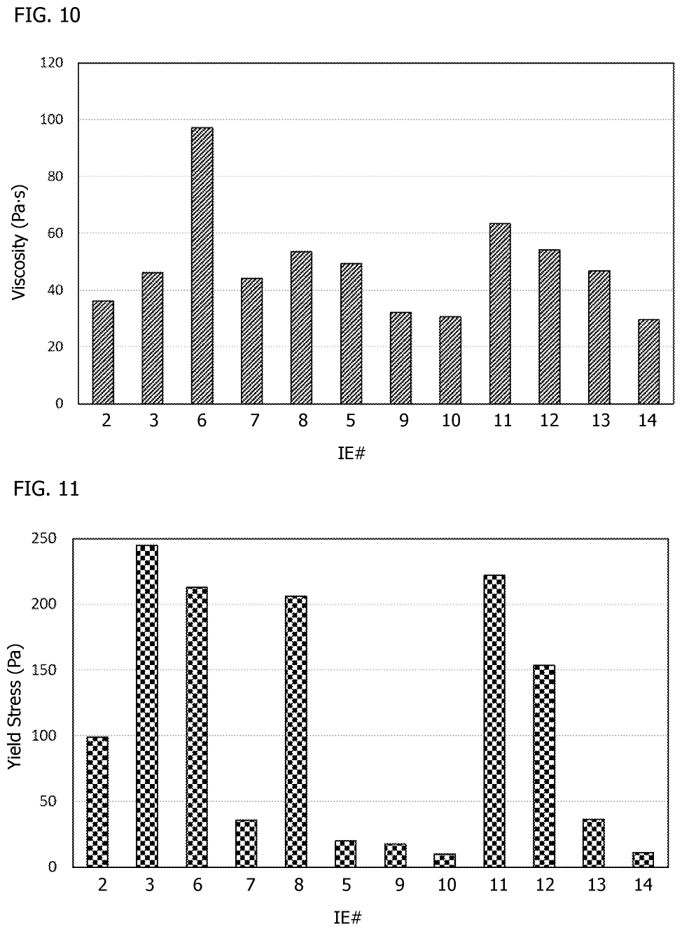

The viscosity and yield stress of slab-able caramels was measured immediately after manufacture on a Brookfield R/S Plus Rheometer with a V3-30-15 vane at a temperature of 45° C. FIG. 8 shows the shear stress-shear rate curves for IE2 and IE3 at 45° C. immediately after manufacture. FIG. 9 shows the shear-thinning behavior of IE2 and IE3, as indicated by a decrease in viscosity with increasing shear rate. The viscosity value was obtained as the ratio of shear stress to shear rate at a shear rate of 7.2 l/s. FIG. 10 shows that the average viscosity of slab-able caramels was in the range of 20-100 Pa·s, preferably 20-60 Pa·s. The yield stress was obtained as the maximum stress value measured at shear rate of 0.05 l/s. FIG. 11 shows that the average yield stress values of slab-able caramels was in the range of 10-250 Pa, preferably 10-40 Pa. Similar to the hardness and stickiness texture results, IE2 had both a viscosity and a yield stress greater than IE3. IE4 was too viscous to obtain viscosity and yield stress values. IE5 had average viscosity and yield stress values of 49.4 Pa·s and 20.2 Pa, respectively.

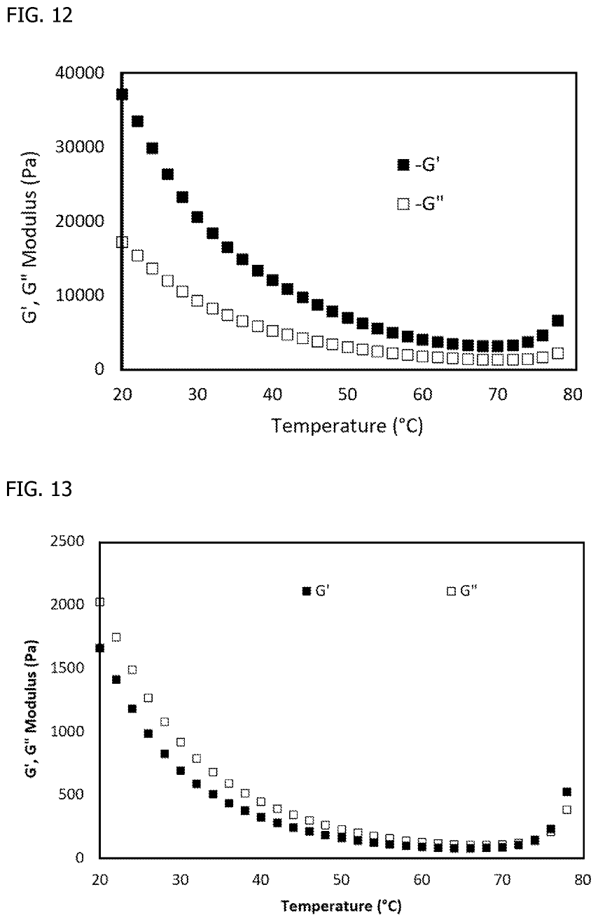

Caramel products exhibit viscoelastic behaviors. Viscoelastic behaviors are related to a semi-solid's response to stress and strain. The storage modulus (G′) and the loss modulus (G″) were measured 24 hours after manufacture on an Anton Paar Rheometer with a temperature sweep program. FIG. 12 is a representative graph showing the storage modulus and loss modulus of IE4. In FIG. 12 storage modulus and loss modulus displayed similar trends: decrease with increasing temperature until reaching 60° C. and then increase with increasing temperature. Storage modulus values are greater than loss modulus values in the temperature range of 20-70° C., indicating a viscoelastic solid behavior of caramel product. This feature ensures that no cold flow exists in caramel product in the above temperature range. Temperature-dependent oscillation measurements were performed on IE5, with the results appearing in FIG. 13. In contrast to IE4, the loss modulus of IE5 was slightly higher than storage modulus, indicating a potential tendency of cold flow at cool temperature when IE5 was freshly made. This tendency disappears when the temperature increases above 70° C.

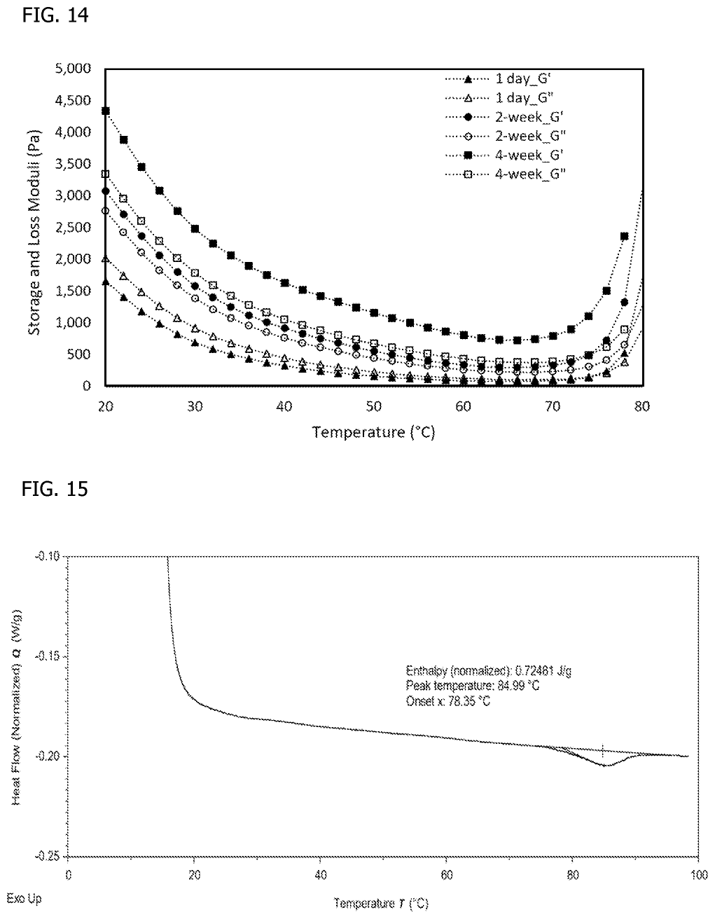

It was also observed that the viscoelastic behavior of IE5 changed with storage or aging time. FIG. 14 demonstrates not only the temperature dependent storage modulus and loss modulus, but also the modulus curves changing over time. IE5 exhibited an increased storage modulus and loss modulus with storage time. IE5 had a viscoelastic liquid behavior when it was freshly produced (G′<G″), but after storage at room temperature for two weeks, this changed to a viscoelastic solid behavior (G′>G″), which indicates no cold flow occurs at this temperature.

Slab-able caramel masses IE2 and IE3 were produced with the same starting formula but by different processing. The process of making IE2 included vacuum boiling (6 min) at 98 mbar while IE3 was made by a similar process but without the vacuum boiling step. The finished caramel products had the same measured water activity (0.58). However, IE2, made with vacuum boiling, had a lower moisture content (16.4%) compared to IE3, made without vacuum boiling (19.5%). The measured textural and rheological properties demonstrate that a slab-able caramel made with vacuum boiling has formed stronger structure than a slab-able caramel made without vacuum boiling. IE2 showed higher hardness and stickiness, higher viscosity and yield stress value. IE2 caramel also showed increased firmness (storage modulus) at higher temperature (T>30° C.) compared to IE3. This data indicates a strong structure formed in a slab-able caramel that is able to resist the deformation.

Slab-able caramels produced by processes of the present disclosure contained undenatured protein component, evidenced by the presence of a thermal denaturation peak measured on a differential scanning calorimeter (DSC). FIG. 15 shows a representative DSC curve with an endothermic peak at about 85° C., which is the denaturation temperature for the whey protein in a caramel mass. The heating scan was run at a rate of 5° C./min from 20 to 100° C. The whey protein fractions α-lactalbumin and β-lactoglobulin undergo thermal denaturation at a temperature of 64 and 76° C., respectively. High-protein caramels show a single broad endothermic peak with a denaturation peak near 85° C. The presence of glycerol and lactose from the whey protein concentrate in the slab-able caramels increased the thermal stability of whey protein.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A caramel comprising water, glycerol, fat, and about 10% by weight or greater of at least one protein source comprising at least one protein.

2. The caramel of claim 1 comprising about 25% by weight or greater of the at least one protein source.

3. The caramel of claim 1, wherein the protein source is at least 80% protein by weight.

4. The caramel of claim 1, wherein the at least one protein is selected from the group consisting of a milk protein, a soluble plant protein, and combinations thereof.

5. The caramel of claim 1, wherein the at least one protein source is selected from the group consisting of a pulse protein source, a lentil protein source, a chickpea protein source, a potato protein source, a rapeseed protein source, a sunflower protein source, an algae protein source, and combinations thereof.

6. The caramel of claim 1, wherein the at least one protein is not in a denatured state in the caramel.

7. The caramel of claim 1, wherein the caramel is slab-able and has a water activity in the range of about 0.49 to about 0.60 at 22° C.

8. The caramel of claim 1, wherein the caramel has a water content of about 12% to about 20% by weight.

9. The caramel of claim 1, wherein the fat is selected from the group consisting of a milk fat, a vegetable oil, and combinations thereof.

10. The caramel of claim 1, wherein the fat is selected from the group consisting of sunflower oil, coconut oil, shea oil, palm oil, palm kernel oil, olive oil, canola oil, cocoa butter, cocoa butter substitute, fractionated soy oil, fractionated cottonseed oil, and combinations thereof.

11. The caramel of claim 1, wherein the caramel comprises about 11% to about 15% fat and about 39% to about 42% glycerol, by weight.

12. The caramel of claim 1, wherein the caramel is free of hydrocolloids and free of antifoaming agents.

13. The caramel of claim 1, wherein the caramel includes about 2% by weight or less of simple sugars.

14. The caramel of claim 1 further comprising at least one additive.

15. A method of forming a caramel comprising:
combining water, glycerol, fat, and about 10% by weight or greater of at least one protein source comprising at least one protein to form a caramel composition; and
hydrating the protein in the caramel composition at a hydrating temperature less than a denaturation temperature of the at least one protein to achieve the caramel having a predetermined water activity without denaturing the at least one protein, wherein the caramel comprises about 25% by weight or greater of the at least one protein source and the at least one protein is not in a denatured state in the caramel.

16. The method of claim 15, wherein the hydrating comprises applying a reduced pressure to the caramel composition.

17. The method of claim 16, wherein the reduced pressure is about 500 mbar or less.

18. The method of claim 15, wherein the hydrating comprises high shear mixing the caramel composition.

19. The method of claim 15, wherein the predetermined water activity is in the range of about 0.49 to about 0.60 at 22° C.

20. The method of claim 15, wherein the hydrating temperature is about 75° C. or less.

21. The method of claim 20, wherein the hydrating temperature is about 60° C. or less.

22. The method of claim 15, wherein the at least one protein source is at least 80% whey protein by weight.

23. The method of claim 15, wherein the hydrating further comprising vacuum boiling the caramel composition at the hydrating temperature.

24. A comestible product comprising:
a protein core layer; and
a layer of a slab-able caramel according to claim 1 adhering to the protein core layer.
